(19) United States
(12) Patent Application Publication
(10) Pub. No.: US 2026/0271172 A1
(43) Pub. Date: Sep. 10, 2026

(54) ACCELERATING CAVITY

(71) Applicant: MITSUBISHI HEAVY INDUSTRIES MACHINERY SYSTEMS, LTD., Kobe-shi, Hyogo (JP)

(72) Inventors: Masashi KIMURA, Hyogo (JP); Nobuyuki SHIGEOKA, Hyogo (JP); Akihiro MIYAMOTO, Hyogo (JP)

(21) Appl. No.: 18/993,641

(22) PCT Filed: Jul. 28, 2023
(86) PCT No.: PCT/JP2023/027835

§ 371 Date: Jan. 13, 2025

(30) Foreign Application Priority Data
Aug. 3, 2022 (JP) 2022-123802

(51) Int. Cl. H05H 7/18

(52) U.S. Cl. CPC H05H 7/18

(57) ABSTRACT

This accelerating cavity comprises: a housing that has a cylindrical shape with conductivity, and is provided in a state where a plurality of divided members divided by a planar division surface along a central axis face each other with a gap therebetween; a plurality of cell parts that are disposed within the housing in a state of being arranged in the axis direction of the central axis of the housing, and communicate with each other by a communication part through which charged particles can pass; and a vacuum manifold that is connected to the plurality of cell parts via the gap.

### RELATED APPLICATIONS

The present application is a National Phase of International Application Number PCT/JP2023/027835 filed Jul. 28, 2023, and claims priority to Japanese Application Number 2022-123802 filed Aug. 3, 2022.

### TECHNICAL FIELD

The present disclosure relates to an accelerating cavity.

### BACKGROUND ART

An accelerating cavity generates accelerating electric fields therein in a case where high-frequency waves are input to the accelerating cavity, and accelerates charged particles such as electrons. As such an accelerating cavity, a configuration is known in which, for example, a plurality of cell portions lined up in an axial direction of a central axis are provided and the cell portions communicate with each other via communication portions (see, for example, PTL 1).

### CITATION LIST

### Patent Literature

[PTL 1] Japanese Unexamined Patent Application Publication No. H01-107499

### SUMMARY OF INVENTION

### Technical Problem

In recent years, a method of forming an accelerating cavity that includes forming a plurality of divided members divided on a dividing surface formed on a plane taken along a central axis in advance and joining the divided members on the dividing surface in a case where the accelerating cavity described above is manufactured has been proposed. In the accelerating cavity manufactured by such a method, a configuration for efficiently evacuating the inside of the accelerating cavity is required.

The present disclosure has been made in view of the above circumstances, and an object of the present disclosure is to provide an accelerating cavity of which the inside can be efficiently evacuated.

### Solution to Problem

An accelerating cavity according to the present disclosure includes a housing that has conductivity and a tubular shape and in which a plurality of divided members divided on planar dividing surfaces taken along a central axis are provided in a state where parts of the dividing surfaces along the plane face each other with a gap therebetween and in which the other parts of the dividing surfaces are joined to each other, a plurality of cell portions that are arranged in the housing in a state of being lined up in an axial direction of the central axis of the housing and communicate with each other via communication portions through which charged particles are capable of passing, and a vacuum manifold that is connected to the plurality of cell portions via the gap.

### Advantageous Effects of Invention

According to the present disclosure, it is possible to provide an accelerating cavity of which the inside can be efficiently evacuated.

### BRIEF DESCRIPTION OF DRAWINGS

FIG. 1 is a plan view showing an example of an accelerating cavity according to a first embodiment.

FIG. 2 is a diagram showing a configuration taken along a cross section taken along line A-A of FIG. 1.

FIG. 3 is a diagram showing a configuration taken along a cross section taken along line B-B of FIG. 2.

FIG. 4 is a cross-sectional view showing an example of an accelerating cavity according to a second embodiment.

FIG. 5 is a diagram showing a configuration taken along a cross section taken along line C-C of FIG. 4.

FIG. 6 is a cross-sectional view showing an example of an accelerating cavity according to a third embodiment.

FIG. 7 is a diagram showing a configuration taken along a cross section taken along line D-D of FIG. 6.

FIG. 8 is a cross-sectional view showing another example of the accelerating cavity according to the third embodiment.

FIG. 9 is a diagram showing a configuration taken along a cross section taken along line E-E of FIG. 8.

### DESCRIPTION OF EMBODIMENTS

Accelerating cavities according to embodiments of the present disclosure will be described below with reference to the drawings. The present invention is not limited by the embodiments. Further, components of the following embodiments include components that can be easily substituted by those skilled in the art or components that are substantially the same as the components of the following embodiments.

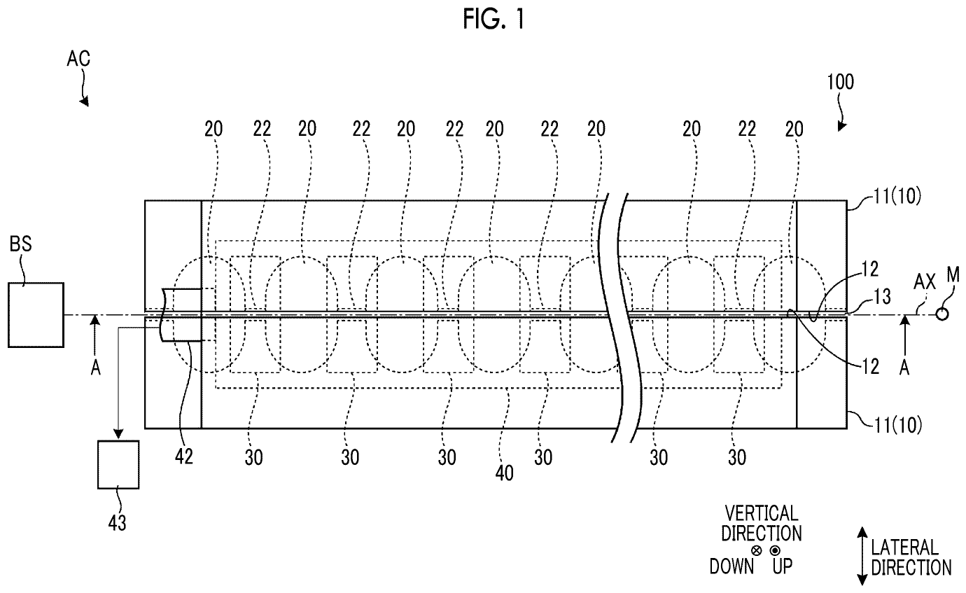

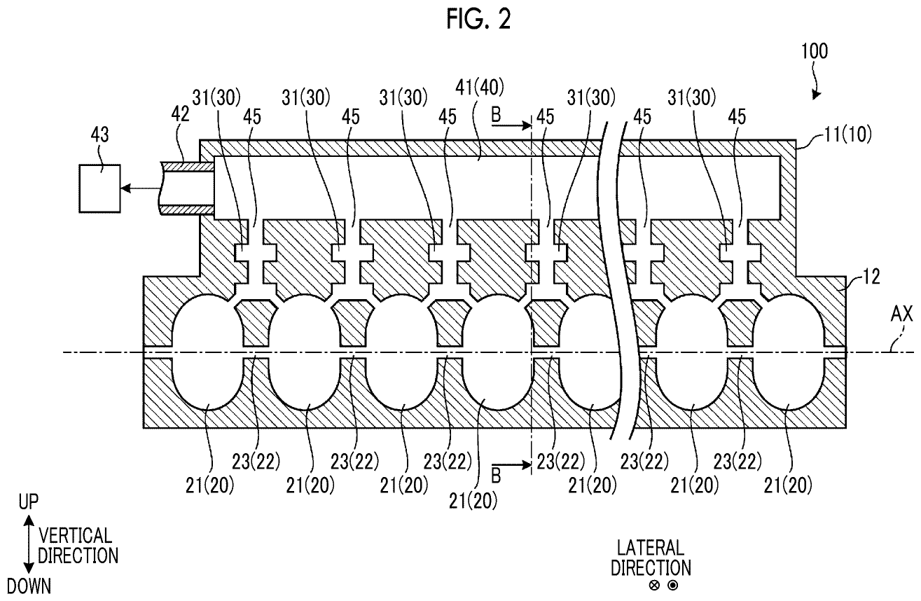

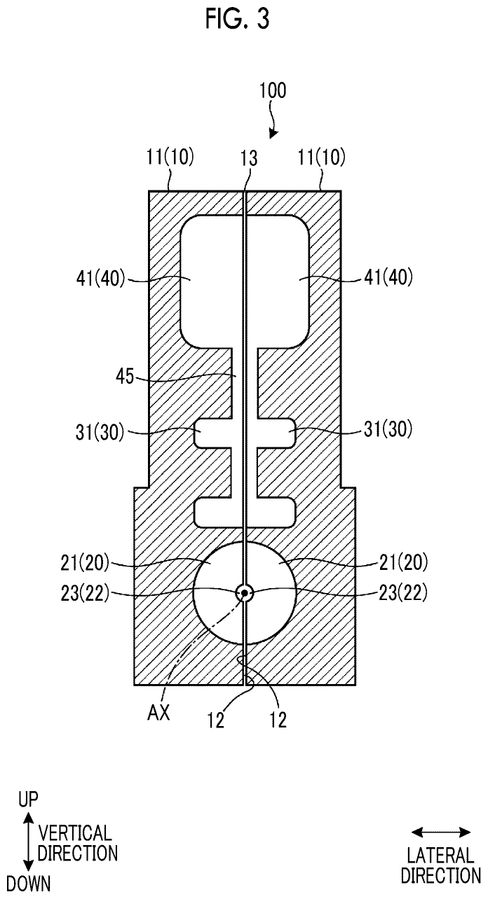

FIG. 1 is a plan view showing an example of an accelerating cavity 100 according to a first embodiment. FIG. 2 is a diagram showing a configuration taken along a cross section taken along line A-A of FIG. 1. Although being not a cross section, a dividing surface 12 is shown with hatching in FIG. 2. FIG. 3 is a diagram showing a configuration taken along a cross section taken along line B-B of FIG. 2.

The accelerating cavity 100 shown in FIGS. 1 to 3 generates accelerating electric fields therein in a case where high-frequency waves are input to the accelerating cavity 100, and accelerates charged particles M such as electrons emitted from a beam source BS. An accelerator AC is formed using the accelerating cavity 100 and the beam source BS. The accelerator AC is used in various fields, such as an academic field such as a high-energy physics experiment and a synchrotron radiation facility, a medical field such as radiation therapy and radiographic examination, and an industrial field such as non-destructive inspection. In the following description, in a case where an axial direction of a central axis AX is described among directions of the accelerating cavity 100, a side facing the beam source BS (a side from which charged particles M are incident) is referred to as an incident side and a side opposite to the incident side (a side from which the charged particles M are emitted) is referred to as an emission side.

As shown in FIGS. 1 to 3, the accelerating cavity 100 according to the present embodiment includes a housing 10, cell portions 20, coupling cavities 30, and a vacuum manifold 40.

The housing 10 has conductivity and a tubular shape. The housing 10 is formed in a state where a plurality of divided members 11 are joined to each other. The divided member 11 has a planar dividing surface 12 taken along the central axis AX. The respective divided members 11 are joined to each other in a state where the dividing surfaces 12 face each other. The respective divided members 11 are provided in a state where a gap 13 is provided between the dividing surfaces 12 facing each other. In the present embodiment, a configuration in which the housing 10 is divided in a lateral direction of the central axis AX along a plane orthogonal to a horizontal plane and passing through the central axis AX will be described as an example. The number of divisions of the housing 10 is not limited to two and may be three or more. Portions of the divided members 11 facing each other have a rounded shape as a whole. For this reason, the local application of a voltage is suppressed.

The cell portions 20 are formed in the housing 10. The cell portions 20 are arranged in a state of being lined up in the axial direction of the central axis AX of the housing 10. The cell portions 20 communicate with each other via communication portions 22 through which charged particles pass. The communication portions 22 are formed along the central axis AX. The cell portions 20 accelerate charged particles with high-frequency waves.

The coupling cavity 30 connects the adjacent cell portions 20. The coupling cavity 30 propagates high-frequency waves between the adjacent cell portions 20. The coupling cavities 30 are disposed at portions that do not contribute to the acceleration of charged particles. The coupling cavities 30 are disposed outside the cell portions 20 in the same direction among directions orthogonal to the central axis AX. In the first embodiment, all the coupling cavities 30 are disposed above the cell portions 20 with respect to the central axis AX as a reference.

The vacuum manifold 40 is a portion that forms negative pressure in a case where the plurality of cell portions 20 are evacuated. The vacuum manifold 40 is connected to a vacuum forming unit 43, such as a vacuum pump, via a pipe 42. In the present embodiment, the vacuum manifold 40 is provided, for example, in the housing 10. The vacuum manifold 40 is formed as one space and is disposed above the respective coupling cavities 30. The vacuum manifold 40 is connected to the plurality of cell portions 20 via the gap 13 between the divided members 11. The respective cell portions 20 are connected to one vacuum manifold 40. Further, in the present embodiment, the vacuum manifold 40 communicates with the coupling cavities 30 via the communication portions 45. Therefore, the vacuum manifold 40 is connected to the plurality of cell portions 20 via the respective coupling cavities 30. With this configuration, the vacuum manifold 40 and the plurality of cell portions 20 are reliably connected to each other.

As shown in FIG. 2, unit cell portions 21 and unit communication portions 23 that form a part of the cell portions 20 and the communication portions 22, unit coupling cavities 31 that form a part of the coupling cavities 30, and a unit manifold 41 that forms a part of the vacuum manifold 40 are formed on the dividing surface 12 of each divided member 11 in the housing 10.

The unit cell portions 21 provided in the respective divided members 11 are combined to form the cell portions 20. The unit communication portions 23 provided in the respective divided members 11 are combined to form the communication portions 22. The unit coupling cavities 31 provided in the respective divided members 11 are combined to form the coupling cavities 30. The unit manifolds 41 formed in the respective divided members 11 are combined to form the vacuum manifold 40.

The accelerating cavity 100 according to the present embodiment includes the housing 10 which has conductivity and a tubular shape and in which the plurality of divided members 11 divided on a plane taken along the central axis AX are provided in a state where the dividing surfaces 12 along the plane face each other with the gap 13 therebetween, the plurality of cell portions 20 that are arranged in the housing 10 in a state of being lined up in the axial direction of the central axis AX of the housing 10 and communicate with each other via the communication portions 22 through which charged particles can pass, and the vacuum manifold 40 that is connected to the plurality of cell portions 20 via the gap 13.

According to this configuration, in a configuration in which the housing 10 is provided in a state where the dividing surfaces 12 of the plurality of divided members 11 face each other with the gap 13 therebetween, the vacuum manifold 40 is connected to the plurality of cell portions 20 via the gap 13. Therefore, the inside of the cell portions 20 can be efficiently evacuated.

In the accelerating cavity 100 according to the present embodiment, the vacuum manifold 40 is connected to the gap 13 of the housing 10 in a direction orthogonal to the central axis AX. According to this configuration, the vacuum manifold 40 can be disposed in the housing 10 in the direction orthogonal to the central axis AX.

In the accelerating cavity 100 according to the present embodiment, all the coupling cavities 30 are arranged on the same side of the cell portions 20 in the direction orthogonal to the central axis AX. Since the coupling cavities 30 are arranged on the same side of the cell portions 20 in the direction orthogonal to the central axis AX to be close to the cell portions 20 in this configuration, directions of electric fields in the direction (vertical direction) orthogonal to the central axis AX are opposite to each other in two coupling cavities 30 connected to one cell portion 20. Accordingly, since the electric fields in the vertical direction cancel out, the shift of the center of the electric field distribution in the cell portion 20 in the vertical direction can be suppressed. For this reason, the bias of a beam of charged particles can be suppressed.

The accelerating cavity 100 according to the present embodiment further includes coupling cavities 30 which are provided in the housing 10 and each of which connects the adjacent cell portions 20, and the coupling cavities 30 are connected to the vacuum manifold 40. According to this configuration, since the vacuum manifold 40 is connected to the cell portions 20 via the coupling cavities 30, the cell portions 20 can be more reliably evacuated by the vacuum manifold 40.

In the accelerating cavity 100 according to the present embodiment, the vacuum manifold 40 is provided in the housing 10. Since the vacuum manifold 40 is provided in the housing 10 in this configuration, the number of components can be reduced.

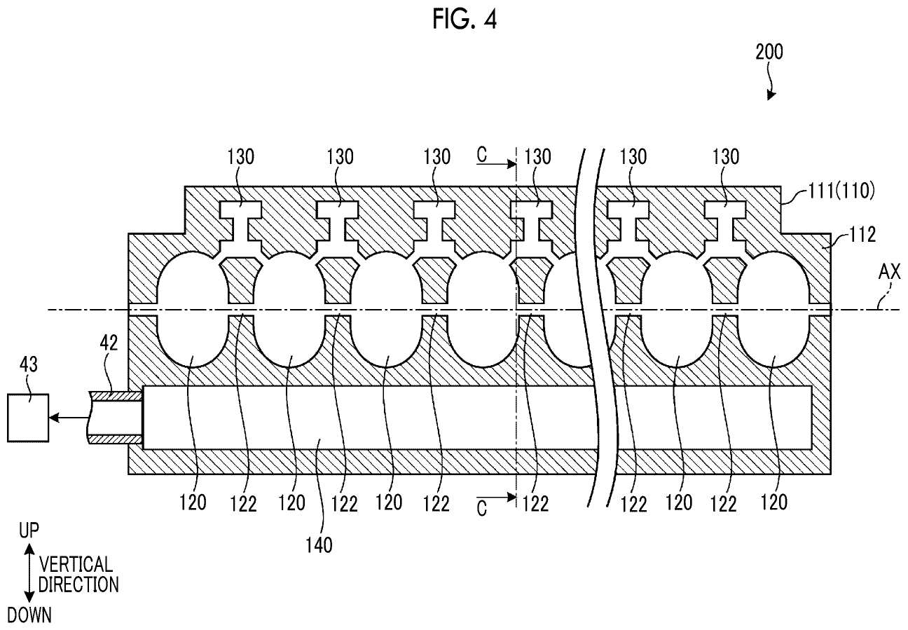

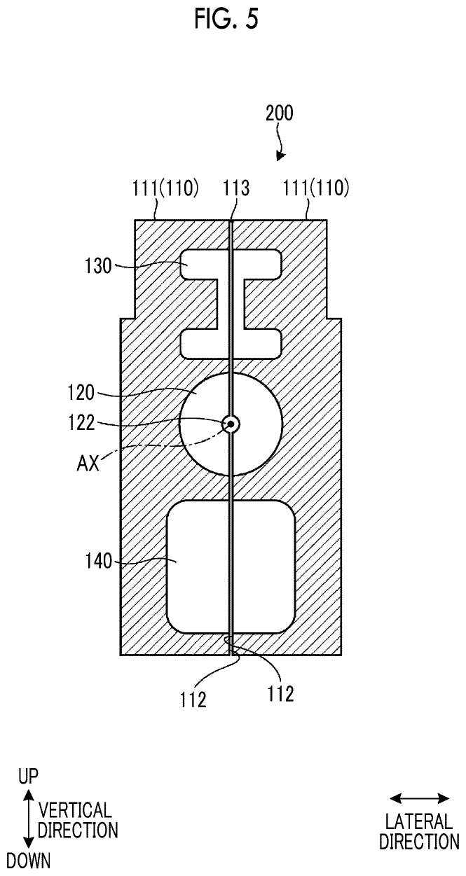

Next, a second embodiment will be described. FIG. 4 is a cross-sectional view showing an example of an accelerating cavity 200 according to a second embodiment. Although being not a cross section, a dividing surface 112 is shown with hatching in FIG. 4. FIG. 5 is a diagram showing a configuration taken along a cross section taken along line C-C of FIG. 4.

As shown in FIGS. 4 and 5, the accelerating cavity 200 according to the second embodiment includes a housing 110, cell portions 120, coupling cavities 130, and a vacuum manifold 140. The housing 110 is formed in a state where a plurality of divided members 111 are joined to each other. The respective divided members 111 are joined to each other in a state where dividing surfaces 112 face each other, and are provided in a state where a gap 113 is provided between the dividing surfaces 112 facing each other. The plurality of cell portions 120 are formed in the housing 110 in a state of being lined up in an axial direction of a central axis AX, and communicate with each other via communication portions 122. Although reference numerals are omitted in the accelerating cavity 200 according to the second embodiment, unit cell portions and unit communication portions that form a part of the cell portions 120 and the communication portions 122, unit coupling cavities that form a part of the coupling cavities 130, and a unit manifold that forms a part of the vacuum manifold 140 are formed on the dividing surface 112 of each divided member 111 in the housing 110 as in the first embodiment.

In the accelerating cavity 200 according to the present embodiment, the coupling cavities 130 and the vacuum manifold 140 are disposed on opposite sides of the cell portions 120 in a direction orthogonal to the central axis AX. That is, the coupling cavities 130 are arranged on one side of the cell portions 120 in the direction orthogonal to the central axis AX, and the vacuum manifold 140 is disposed on the other side opposite to the one side of the cell portions 120. In the example shown in FIG. 4, the coupling cavities 130 are arranged on an upper side of the cell portions 120, and the vacuum manifold 140 is disposed on a lower side of the cell portions 120.

In this configuration, the vacuum manifold 140 and the cell portions 120 are connected to each other via the gap 113. Therefore, the cell portions 120 can be evacuated via the gap 113 by the vacuum manifold 140. For this reason, the cell portions 120 can be efficiently evacuated.

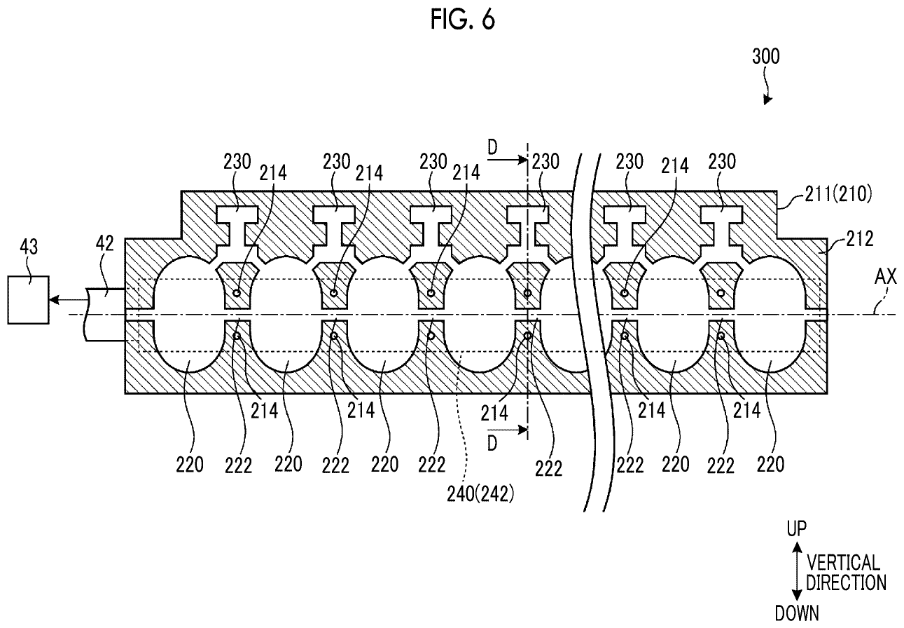

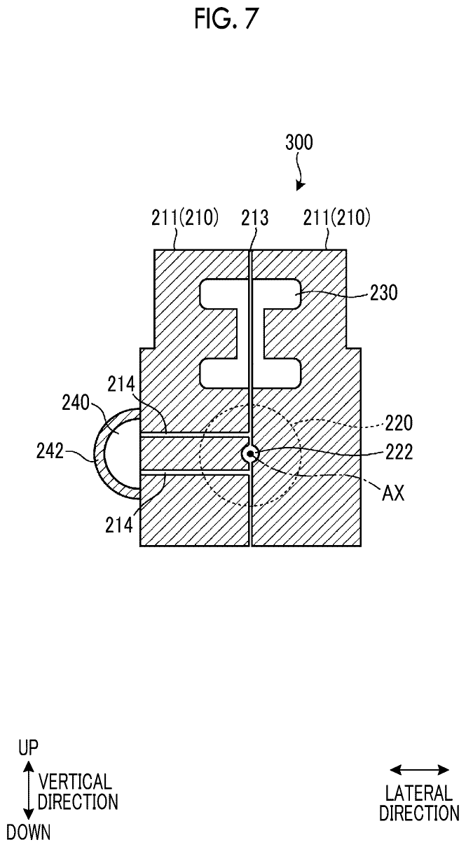

Next, a third embodiment will be described. FIG. 6 is a cross-sectional view showing an example of an accelerating cavity 300 according to a third embodiment. Although being not a cross section, a dividing surface 212 is shown with hatching in FIG. 6. FIG. 7 is a diagram showing a configuration taken along a cross section taken along line D-D of FIG. 6.

As shown in FIGS. 6 and 7, the accelerating cavity 300 according to the third embodiment includes a housing 210, cell portions 220, coupling cavities 230, and a vacuum manifold 240. The housing 210 is formed in a state where a plurality of divided members 211 are joined to each other. The respective divided members 211 are joined to each other in a state where the dividing surfaces 212 face each other, and are provided in a state where a gap 213 is provided between the dividing surfaces 212 facing each other. The gap 213 is sealed by welding, adhesion, a seal member, or the like at a portion excluding the vacuum manifold 240 provided outside the housing 210 and communication portions 222. The plurality of cell portions 220 are formed in the housing 210 in a state of being lined up in an axial direction of a central axis AX, and communicate with each other via the communication portions 222. Although reference numerals are omitted in the accelerating cavity 300 according to the third embodiment, unit cell portions and unit communication portions that form a part of the cell portions 220 and the communication portions 222, unit coupling cavities that form a part of the coupling cavities 230, and a unit manifold that forms a part of the vacuum manifold 240 are formed on the dividing surface 212 of each divided member 211 in the housing 210 as in each embodiment described above.

As shown in FIGS. 6 and 7, the vacuum manifold 240 is provided outside the housing 210 in the accelerating cavity 300 according to the third embodiment. That is, the vacuum manifold 240 and the housing 210 are provided as separate components. With this configuration, the degree of freedom of the disposition of the vacuum manifold 240 is increased.

In the example shown in FIGS. 6 and 7, the vacuum manifold 240 is provided in a manifold forming member 242 disposed on a lateral side of the housing 210 in the axial direction of the central axis AX. The manifold forming member 242 has, for example, an arc-shaped cross section as shown in FIG. 7, but is not limited to this configuration. The manifold forming member 242 may have other shapes such as a rectangular shape or a triangular shape.

As shown in FIGS. 6 and 7, the housing 210 includes exhaust holes 214. The exhaust holes 214 are disposed in the housing 210 at positions away from each cell portion 220. The exhaust holes 214 are formed in a direction intersecting the dividing surface 212. The exhaust holes 214 communicate with the gap 213 and the vacuum manifold 240.

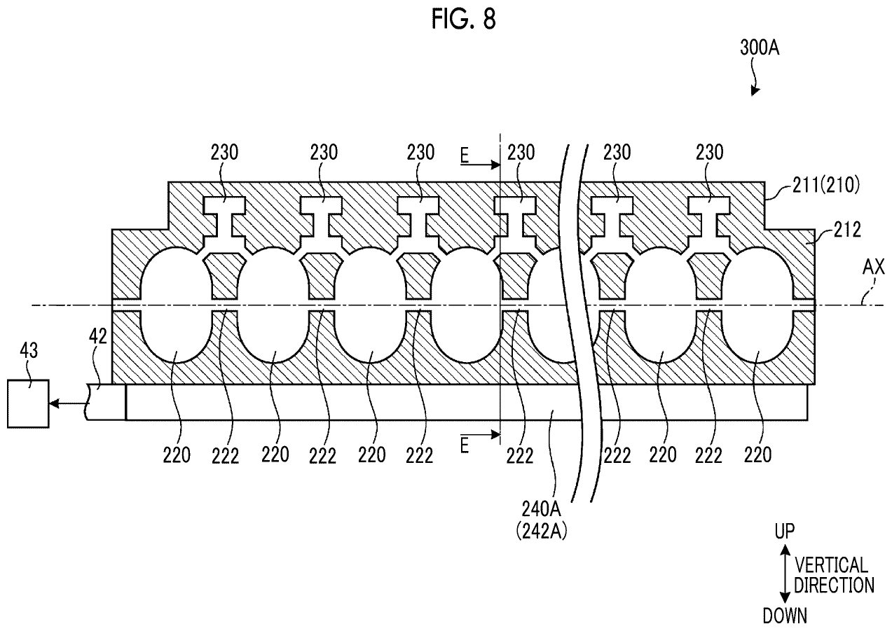

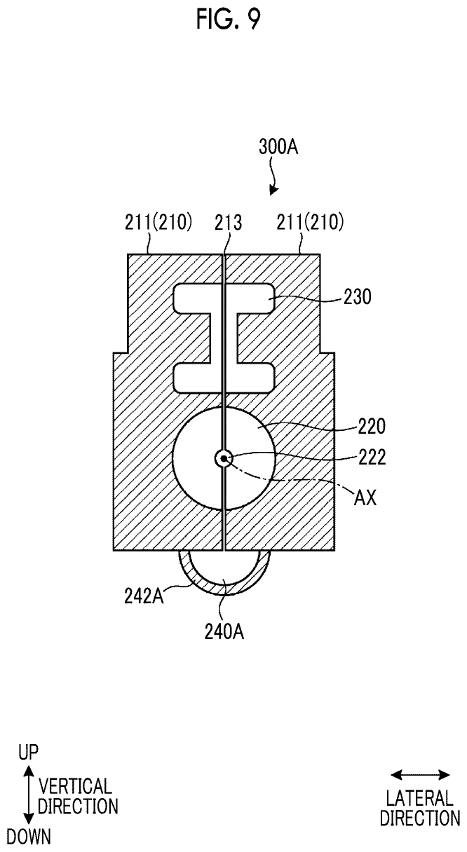

FIG. 8 is a cross-sectional view showing another example of the accelerating cavity according to the third embodiment. Although being not a cross section, a dividing surface 212 is shown with hatching in FIG. 8. FIG. 9 is a diagram showing a configuration taken along a cross section taken along line E-E of FIG. 8. The configuration of an accelerating cavity 300A shown in FIGS. 8 and 9 is different from the configuration of the accelerating cavity 300 in that a vacuum manifold 240A (manifold forming member 242A) is disposed under the housing 210. In this configuration, the vacuum manifold 240A is connected to the cell portions 220 via the gap 213.

In the accelerating cavities 300 and 300A according to the present embodiment, the vacuum manifold 240, 240A is provided outside the housing 210. With this configuration, the degree of freedom of the disposition of the vacuum manifold 240, 240A is increased.

Further, in the accelerating cavity 300, the housing 210 includes the exhaust holes 214 that are formed in a direction intersecting the dividing surface 212 at positions away from the plurality of cell portions 220 and communicate with the gap 213 and the vacuum manifold 240 provided outside the housing 210. With this configuration, the cell portions 220 can be efficiently evacuated via the exhaust holes 214 by the vacuum manifold 240.

As described above, an accelerating cavity according to a first aspect of the present disclosure includes a housing 10 which has conductivity and a tubular shape and in which a plurality of divided members 11 divided on a plane taken along a central axis AX are provided in a state where parts of dividing surfaces 12 along the plane face each other with a gap 13 therebetween and in which the other parts of the dividing surfaces 12 are joined to each other, a plurality of cell portions 20 that are arranged in the housing 10 in a state of being lined up in an axial direction of the central axis AX of the housing 10 and communicate with each other via communication portions 22 through which charged particles are capable of passing, and a vacuum manifold 40 that is connected to the plurality of cell portions 20 via the gap 13.

According to this configuration, in a configuration in which the housing 10 is provided in a state where the dividing surfaces 12 of the plurality of divided members 11 face each other with the gap 13 therebetween, the vacuum manifold 40 is connected to the plurality of cell portions 20 via the gap 13. Therefore, the inside of the cell portions 20 can be efficiently evacuated.

According to a second aspect of the present disclosure, in the accelerating cavity according to the first aspect, the vacuum manifold 40 is connected to the gap 13 of the housing 10 in a direction orthogonal to the central axis AX.

According to this configuration, the vacuum manifold 40 can be disposed in the housing 10 in the direction orthogonal to the central axis AX.

According to a third aspect of the present disclosure, the accelerating cavity according to the first or second aspect further includes coupling cavities 30 which are provided in the housing 10 and each of which connects the adjacent cell portions 20, and all the coupling cavities 30 are arranged on the same side of the cell portions 20 in a direction orthogonal to the central axis AX.

Since the coupling cavities 30 are arranged on the same side of the cell portions 20 in the direction orthogonal to the central axis AX to be close to the cell portions 20 in this configuration, the center of the electric field distribution in the direction orthogonal to the central axis AX can be aligned with the central axis AX. For this reason, the bias of a beam of charged particles can be suppressed.

According to a fourth aspect of the present disclosure, in the accelerating cavity according to the third aspect, the coupling cavities 30 are connected to the vacuum manifold 40.

According to this configuration, since the vacuum manifold 40 is connected to the cell portions 20 via the coupling cavities 30, the cell portions 20 can be more reliably evacuated by the vacuum manifold 40.

According to a fifth aspect of the present disclosure, in the accelerating cavity according to the third aspect, the coupling cavities 130 and the vacuum manifold 140 are disposed on opposite sides of the cell portions 120 in the direction orthogonal to the central axis AX.

In this configuration, the vacuum manifold 140 and the cell portions 120 are connected to each other via the gap 113. Therefore, the cell portions 120 can be evacuated via the gap 113 by the vacuum manifold 140. For this reason, the cell portions 120 can be efficiently evacuated.

According to a sixth aspect of the present disclosure, in the accelerating cavity according to any one of the first to fifth aspects, the vacuum manifold 40 is provided in the housing 10.

Since the vacuum manifold 40 is provided in the housing 10 in this configuration, the number of components can be reduced.

According to a seventh aspect of the present disclosure, in the accelerating cavity according to any one of the first to fifth aspects, the vacuum manifold 240 is provided outside the housing 210.

With this configuration, the degree of freedom of the disposition of the vacuum manifold 240 is increased.

According to an eighth aspect of the present disclosure, in the accelerating cavity according to the seventh aspect, the housing 210 includes exhaust holes 214 that are formed in a direction intersecting the dividing surface 212 at positions away from the plurality of cell portions 220 and communicate with the gap 213 and the vacuum manifold 240 provided outside the housing 210.

With this configuration, the cell portions 220 can be efficiently evacuated via the exhaust holes 214 by the vacuum manifold 240.

### REFERENCE SIGNS LIST

10, 110, 210: housing
11, 111: divided member
12, 112, 212: dividing surface
13, 113, 213: gap
20, 120, 220: cell portion
21: unit cell portion
22, 45, 122: communication portion
23: unit communication portion
30, 130: coupling cavity
31: unit coupling cavity
40, 140, 240: vacuum manifold
41: unit manifold
42: pipe
43: vacuum forming unit
100, 200, 300, 300A: accelerating cavity
214: exhaust hole
242: manifold forming member
AC: accelerator
AX: central axis
BS: beam source
M: charged particle

1. An accelerating cavity comprising:
a housing which has conductivity and a tubular shape and in which a plurality of divided members divided on a plane taken along a central axis are provided in a state where parts of dividing surfaces along the plane face each other with a gap therebetween and in which the other parts of the dividing surfaces are joined to each other;
a plurality of cell portions that are arranged in the housing in a state of being lined up in an axial direction of the central axis of the housing and communicate with each other via communication portions through which charged particles are capable of passing; and
a vacuum manifold that is connected to the plurality of cell portions via the gap.

2. The accelerating cavity according to claim 1,
wherein the vacuum manifold is connected to the gap of the housing in a direction orthogonal to the central axis.

3. The accelerating cavity according to claim 1, further comprising:
coupling cavities which are provided in the housing and each of which connects the adjacent cell portions,
wherein all the coupling cavities are arranged on a same side of the cell portions in a direction orthogonal to the central axis.

4. The accelerating cavity according to claim 3,
wherein the coupling cavities are connected to the vacuum manifold.

5. The accelerating cavity according to claim 3,
wherein the coupling cavities and the vacuum manifold are disposed on opposite sides of the cell portions in the direction orthogonal to the central axis.

6. The accelerating cavity according to claim 1,
wherein the vacuum manifold is provided in the housing.

7. The accelerating cavity according to claim 1,
wherein the vacuum manifold is provided outside the housing.

8. The accelerating cavity according to claim 7,
wherein the housing includes an exhaust hole that is formed in a direction intersecting the dividing surface at a position away from the plurality of cell portions and communicates with the gap and the vacuum manifold provided outside the housing.
